(19) United States
(12) Patent Application Publication
(10) Pub. No.: US 2024/0256412 A1
(43) Pub. Date: Aug. 1, 2024

(54) ROLE MANAGEMENT OF DEVICE NODES IN AN AGGREGATED NODE SYSTEM

(71) Applicant: Hewlett-Packard Development Company, L.P., Spring, TX (US)

(72) Inventors: Tyler SIMS, Corvallis, OR (US); Qiwei WANG, Palo Alto, CA (US); William ALLEN, Corvallis, OR (US)

(21) Appl. No.: 18/560,850

(22) PCT Filed: May 24, 2021
(86) PCT No.: PCT/US2021/033897

§ 371 Date: Nov. 14, 2023

(51) Int. Cl. G06F 11/30

(52) U.S. Cl. CPC G06F 11/3055; G06F 11/3006

(57) ABSTRACT

A method for managing roles of device nodes in an aggregated system. Information regarding a device node of an aggregated node group is determined. Each device node of the aggregated node group has multiple power level states. One of a plurality of roles of the device node is determined based upon the information. Each role has an associated power level state. The power level state associated with the role or function of the device node is enabled. The device node is instructed to actuate the determined role.

### BACKGROUND

Asset tracking systems often utilize tracking devices to manage, locate and track assets. Such systems find use in inventory control management, loss prevention, etc.

### BRIEF DESCRIPTION OF THE DRAWINGS

FIG. 1 illustrates an example visibility management system which may employ a device node role management system according to examples of the present disclosure.

FIG. 2 illustrates another example visibility management system which may employ a device node role management system according to examples of the present disclosure.

FIG. 3 illustrates a process for managing roles of device nodes in an aggregated node system according to an example of the present disclosure.

FIG. 4 illustrates an example mesh topology of the visibility management system of FIG. 2.

FIG. 5 illustrates an example block diagram for determining information regarding device nodes according to the present disclosure.

FIG. 6 illustrates a computer system architecture suitable for implementing examples or components to manage roles of device nodes in an aggregated node system according to examples of the present disclosure.

### DETAILED DESCRIPTION

Asset tracking systems may include an aggregated node system. The aggregated node system may include numerous embeddable device nodes that communicate with each other to facilitate asset tracking. However, many such device nodes in an aggregated node system can perform only limited functions due to power and communication constraints.

The present disclosure addresses the foregoing by providing a method for managing roles of device nodes in aggregated node groups. The aggregated node groups may be employed in an asset tracking environment to determine and enable roles and functions for device nodes on an ad hoc basis. A device node role management system determines information regarding the device node. Based on that information, the system determines a role or function for the device node to perform. The system determines a power level state associated with the role to be performed by the device node. If necessary, the system transmits sufficient energy to enable the device node to enter the power level state associated with the role to be performed by the device node.

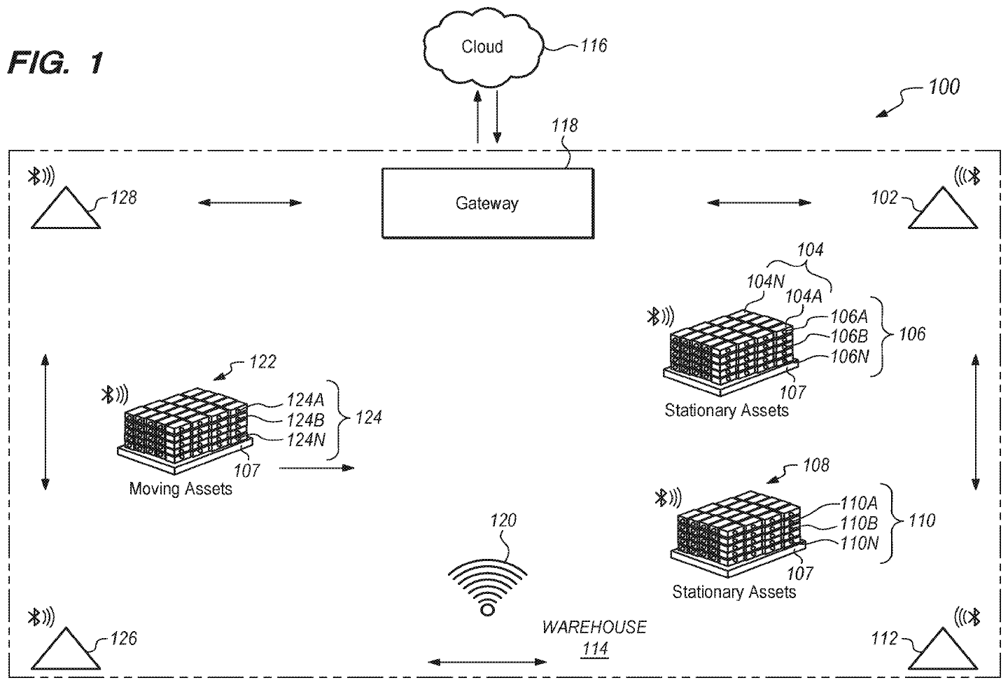

FIG. 1 illustrates an example visibility management system 100 which may employ a device node role management system according to examples of the present disclosure.

In FIG. 1, visibility management system 100 includes four anchor nodes 102, 112, 126 and 128 that are communicatively coupled to aggregated node groups 106, 110 and 124. Each anchor node 102, 112, 126 and 128 might be a physical element with wireless communication capabilities. Each anchor node 102, 112, 126 and 128 also has a unique ID (identification) that can be exchanged to facilitate management of aggregated node groups 106, 110 and 124. The anchor nodes may also have an external power supply to operate in a high capability state.

As shown, anchor nodes 102, 112, 126 and 128 are stationary with known coordinates. In this example, anchor nodes 102, 112, 126 and 128 are positioned around the periphery of a warehouse 114 specifically at the corners of the warehouse. This positioning facilitates determining the absolute location of aggregated node groups 106, 110, and 124 and their device nodes. The positioning also maximizes communication dispersion between the anchor nodes 102, 112, 126 and 128 and aggregated node groups 106, 110 and 124. The positioning and the number of anchor nodes can vary depending upon the warehouse layout and the particular implementation.

Although anchor nodes are referred to as being stationary, an anchor node can be mobile. For example, an anchor node may be incorporated in a robot that moves around the warehouse. Such a movable anchor node facilitates a dynamically flexible zone of operation. Further, if for instance, a weak link in the infrastructure nodes exist or an anchor node becomes damaged or has low power life, a movable robot with an on-board anchor node can replace the damaged anchor node in the mesh to restore network health.

Referring to FIG. 1, visibility management system 100 also includes aggregated node groups 106, 110 and 124, each respectively associated with assets 104, 108 and 122. By “associated with,” it is meant that each device node of aggregated node group 106, 110 and 124 is functionally or physically integrated into a corresponding asset. For example, device node 106A is physically integrated or attached to asset 104A.

Here, assets 104, 108 and 122 may be any tangible item, the location of which is to be tracked. In this example, assets may be supply chain consumables such as printer cartridges that are to be tracked. Such assets 104, 108 and 122 may be physically clustered onto pallets 107 and can be moved (e.g., via forklift). The assets may be disaggregated (possibly multiple times) as part of a larger process. It is possible to find hundreds or even thousands of such assets aggregated onto multiple pallets 107, each holding 5,000 packages (for example) and each package/asset having a corresponding device node.

When thousands of device nodes are concentrated in a small volume, likelihood of channel collision increases. Many of the concentrated nodes cannot be detected due to channel collision. Such device nodes may transmit contemporaneously without synchronization so that asset tracking via such device nodes is limited and unreliable. Visibility management system 100 of the present disclosure may be employed to track movement and provenance of assets 104, 108 and 122 in a global supply chain without high channel collision.

Referring to FIG. 1, each aggregated node group 106, 110 and 124 includes multiple device nodes physically clustered in close proximity to each other. That is, each aggregated node group 106, 110 and 124 is a set of device nodes. As an example, aggregated node group 106 includes multiple device nodes 106A, 106B, . . . 106N. As another example, aggregated node group 110 includes multiple device nodes 110A, 110B, . . . 110N. And aggregated node group 124 similarly includes plural device nodes 124A, 124B . . . 124N.

Here, a device node (e.g., 106A, 110A, 124A) is a physical element with wireless communication capabilities. Thus, device nodes may communicate with the four anchor nodes 102, 112, 126 and 128. Each device node may have an on-board energy supply such as a battery as well as a unique identification that can be exchanged to facilitate device node management. The device nodes and aggregated node groups 106, 110, 124 may be moved from one location to another.

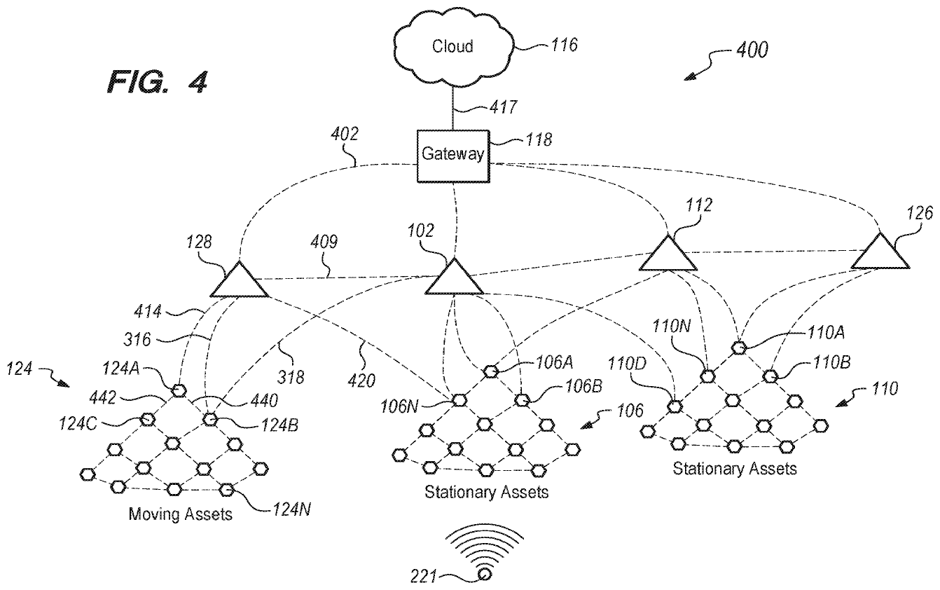

In FIG. 1, aggregated node groups 106, 110, 124 can also form a mesh network between the device nodes and anchor nodes 102, 112, 126 and 128 as further described with reference to FIG. 4. Communication between device nodes in the mesh network might be via Bluetooth LE (low energy), 802.15.4, Wi-Fi, or other wireless mesh protocols. Communication between device nodes of aggregated node groups 106, 110 and 124 and anchor nodes 102, 112, 126 and 128 can also be via Bluetooth LE. The present disclosure significantly reduces channel collision because communication signals are spatially and temporally synchronized so that systems such as Bluetooth can be selected as a design option.

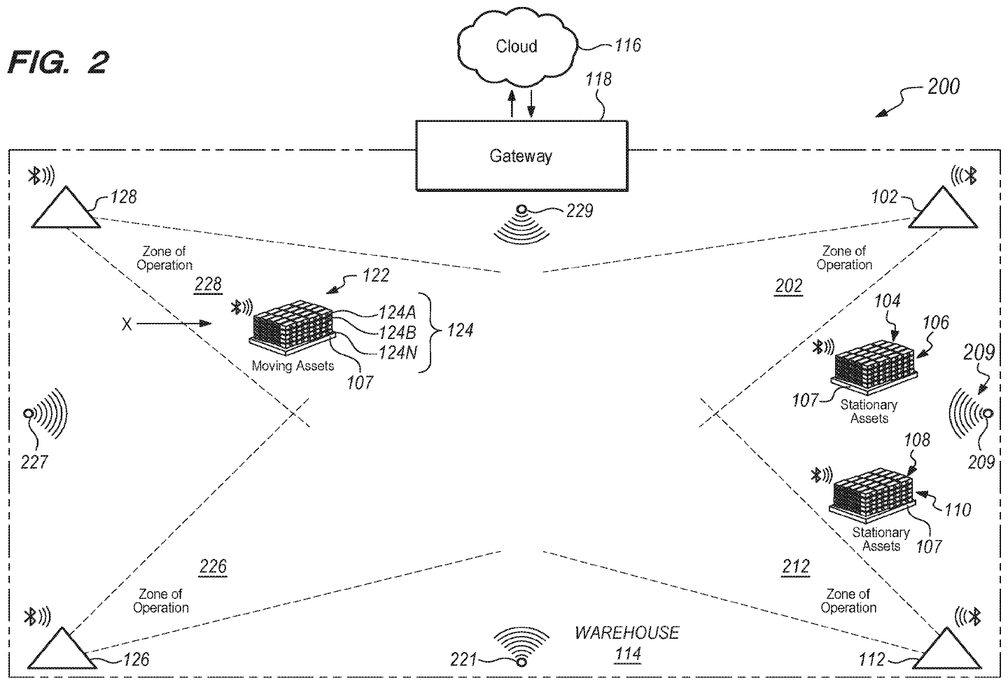

Referring now to FIG. 1, visibility management system 100 also includes a reflected energy device (RED) 120 communicatively coupled to gateway 118 and cloud 116. RED 120 is a stationary communication device with a fixed location within or proximate to a zone of operation (see FIG. 2). RED 120 can sense energy reflected from device nodes 106, 110 and 124. This information is used to aid in precisely determining the absolute position of device nodes and their associated assets. RED 120 can power the devices up from low state with the energy that is emitted onto the targeted object. Thereafter, the RED 120 can sense the reflected energy image and perform signal processing to cause actions for determining position, content verification, and other available outputs/signal state changes from the reflected energy data.

In one example, RED 120 might be an optical camera. Such camera units may have an integrated light source, or the light source may be an overhead light. In other examples, the RED may be an optical phased array (OPA) with standard camera, a heterodyne OPA, an ultrasonic phased array, a radio phased array, a magnetic scalar wave device, or other energy emitting devices. Any suitable portion of the electromagnetic spectrum, ultrasound, etc. may be used for the energy waves, and the RED may be an array designed to operate in the desired portion of the electromagnetic, sound or other directable energy form (e.g., RF/microwave, Terahertz, infrared, visible light, ultra violet, x-ray, etc.).

Here, each asset (e.g., 104A) might include a mark that is detectible by RED 120. RED 120 can also generate spatial information regarding detected items in the field of view. For example, this generation may occur with multiple RED sensors working cooperatively, via computer vision techniques for stereo image processing to gain depth information.

An example of an array with beam steering radar that may be applied to obtain spatial information has the following elements: mapping location of tagged objects as a reference down to centimeter (cm) resolution; ability to power up items when the energy paints the objects but otherwise will not power up the space around unpainted objects.

In accordance with examples of the present disclosure, visibility management system 100 may employ a device node role management system to allow specific device nodes to perform roles or functions.

Each device node of the aggregated node group has multiple power level states and each role of a device node is associated with a power level state. In a low power level state, the device node can allocate fewer communication resources, can be in a minimal state for mesh operation, or if a node reports into another node that node can go into an idle or standby state or sleep mode. In one example of this power level state, the device node has lower capabilities, takes no action, and may simply await an instruction signal to enter another power level state. As noted, in this power state, there may be a minimum level of communication to keep the mesh (e.g., mesh network topology 400) alive. At higher power level states, the device nodes may perform other roles or functions for asset tracking. For example, at a higher power level state, the device node may allocate communication resources to increase frequency of RSSI (received signal strength indicator) measurements. In this power level state, the device node is awake to communicate with other neighboring device nodes and with the anchor nodes.

Use and operation of visibility management system 100 will now be described with reference to FIG. 2.

FIG. 2 illustrates an example visibility management system 200 according to the present disclosure.

Unlike FIG. 1 in which visibility management system 100 employs a single RED 120, visibility management system 200 of FIG. 2 utilizes at least four REDs 209, 221, 227 and 229. Here, the multiple REDs ensure that all surfaces of assets 104, 108 and 122 remain visible to energy signals from the REDs. Although shown as single REDs, each RED, 209, 221, 227 and 229 may be comprised of multiple REDs.

In FIG. 2, visibility management system 200 also includes a zone of operation for each of anchor nodes 102, 112, 126 and 128. A zone of operation is a volume where aggregated node groups 106, 110 and 124 are enabled to communicate with anchor nodes 102, 112, 126 and 128. In this zone of operation, assets 104, 108 and 112 can also be scanned by REDs 209, 221, 227 and 229.

In operation, visibility management system 200 is at an initial power level state. In this power level state, assets that are stationary are outside the zones of operation. Thus, as shown, assets 104 and assets 108 are stationary and are outside zone of operation 202 and zone of operation 212 respectively. Therefore, none of the REDs 209, 221, 227, and 229 receive energy reflected from assets 104 or 108.

Furthermore, in the initial power level state, device nodes of aggregated node groups 106, 110 and 124 are in a first power level state (low power level state). In one example, in this power level state, device nodes 106, 110 and 124 are not in communication with anchor nodes 102, 112, 126 and 128. In another example, in this low power level state, device nodes are scheduled to communicate with anchor nodes 102, 112, 126 and 128 at specific predetermined intervals depending upon the expected movement of aggregated node groups 106, 110 and 124.

When more assets such as moving assets 122 enter into the zone of operation, the assets are switched to a higher power level state. Such entry might be via a forklift (not shown) that engages pallet 107 to move assets 122 to another location. As shown, pallet 107 holding assets 122 is in motion and has moved from a position X that is outside zone of operation 228 to within zone of operation 228.

Upon assets 122 moving into zone of operation 228, at least one of REDs 209, 221, 227 or 229 transmits energy to aggregated node group 124 containing assets 122. The energy is then reflected back to REDs 209, 221, 227 or 229 to detect motion (for example) of assets 122. Each RED 209, 221, 227 and 229 has spatial and temporal discrimination so that motion can be detected adding in a securely transmitted signal that can be interpreted as an image or stream vs a known library or model by analyzing its output.

Specifically, in one example, the energy is transmitted by RED 221. This transmitted energy is then reflected from aggregated node group 124 and/or assets 122. The reflected energy is received by RED 221 to detect the movement/motion (for example) of aggregated node group 124 and assets 122.

In this example, when motion of aggregated node group 124/assets 122 is detected within zone of operation 228, the anchor node closest to zone of operation 228 is identified. Here, anchor node 128 is identified as the closest anchor node. In one example, visibility management system 200 then utilizes anchor node 128 to relay power level state change instruction signals to change the operating power level states of device nodes of aggregated node group 124. In another example, it is RED 221 that is used to transmit power level state change instruction signals to change the operating power level states of device nodes of aggregated node group 124. In this example, the RED 221 may send power and signal to cause interruption to the power level state change circuitry of a device node. In this manner, in-band radio traffic is not increased.

Here, a first change power level state instruction signal can direct the device nodes of aggregated node group 124 to change from a low (or lower) power level state to a high (or higher) power level state. In this higher power level state, more frequent RSSI measurement may occur, and device identification and location information may be exchanged and communicated to anchor node 128 for storage or processing by computing resources at gateway 118.

In this higher power level state, device nodes of aggregated node group 124 are awake and begin more frequent communication with anchor node 128 (or an appropriate RED) including exchanging ID information with anchor node 128. The communication with anchor node 128 can be direct or via the mesh network. In turn, anchor node 128 measures the RSSI from each device node and between each device node. Anchor node 128 then forwards all of the information to gateway 118.

Gateway 118 uses the RSSI information and the known location of anchor node 128 (and other anchor nodes) to determine the location of aggregate node group 124 and all device nodes within the aggregate node group. The position of aggregate node group 124 may be determined based on its distance from known anchor nodes, each of which is used as a reference. Examples of techniques that can be used include RSSI, Angle of Arrival (AoA), Angle of Departure (AoD), and Time of Flight (ToF). Thus, gateway 118 can determine how many corresponding assets there should be and whether an asset is missing.

Thus, the power level state change instruction signals cause communication resources to operate at a different power performance point. Communication resources can direct when and how device nodes are assigned to communicate wirelessly. A resource may include channel (frequency), future time windows—when communication is allowed and expected and/or radio power level which affects transmitted signal strength.

In FIG. 2, gateway 118 and/or external computer elements can implement holistic policies for visibility management system 200 performance. For example, an application may require device nodes 124A, 124B and 124C to respond to a command to move to high power and frequent mesh network communications to be propagated to all aggregated node group 124 devices within n seconds.

With such centrally administered control, the present disclosure facilitates interrogation of the system's mesh network topology to determine the power level state-change-command latency (typical and worst case) for each device node under a given set of node power-performance operating points.

This change in power level state may be temporary. After either a time-out or upon detection that movement of aggregated node group 124/assets has ceased, instructions to enter the low or lower power level state are sent to the device nodes via a RED (e.g., RED 227), an anchor node (e.g., anchor node 128) or a communication device. Note that as used here, the communication device may be a RED or an anchor node or a separate communication device that is part of the network and is in communication with the device nodes.

Specifically, upon detecting the power level state change event such as cessation of movement or upon a timeout, the appropriate device (an anchor node, a RED or another communication device) may communicate a second change power level state instruction signal that directs the device nodes to enter a low (or lower) power level state. In this manner, communication assets in play are adjusted dynamically allowing power to be used efficiently. Note that the device nodes can be given a program ability to execute a delayed power level state change command. Thus, after a commanded time interval, a device node may enter a different power level state to enter a sleep mode or perform a different role.

Assigning roles and controlling power level states may be done externally and on an ad hoc basis for each device node. The device node role management system (external computing system) will determine information regarding individual device nodes. The information is updated through constant feedback from the system and artificial intelligence-based learning models. Based upon an evaluation of this information the system may assign roles and enable associated power level states. The device node role management system then instructs the device node to enter the identified power level states (e.g., via the RED, or anchor or routing nodes) and perform the role.

Examples of the present disclosure may include many different device node roles with each role having an associated power level state. Roles may include communication and routing functions, analysis roles, which may include building inference and learning models, security roles, including device node authentication and monitoring, as well as other roles to effect visibility management.

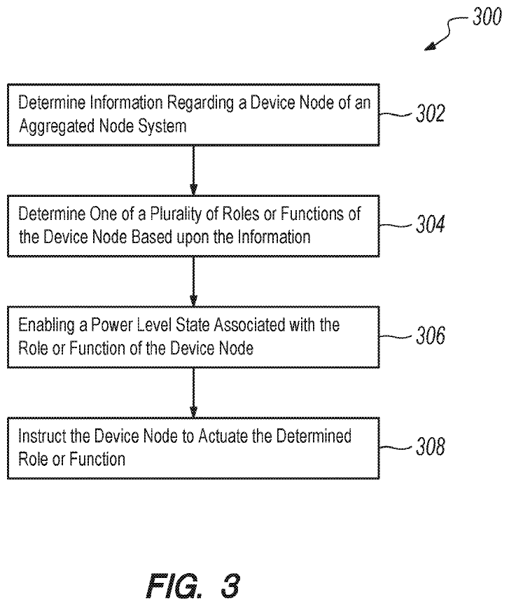

FIG. 3 illustrates a process for managing roles of device nodes in an aggregated node system according to an example of the present disclosure. Process 300, illustrated in FIG. 3 may be representative of computer readable instructions that may be executed by a processor to implement a process for device node role management. Process 300, shown in FIG. 3 begins with operation 302 in which information regarding a device node of an aggregated node system is determined.

The information regarding the device node may include many aspects of the device node and the surrounding environment. This may include, for example, location and movement of the device node, vibration, or other factors affecting the environment of the device node. The information may also include, for example, the products attached to the device nodes or measurements of the device nodes (e.g., measurements of interference when trying to communicate or measurements of which nodes are responsive to communication attempts).

The information may be obtained through various methods and sources including by transmitting energy to the aggregated node group of the device node. The energy may be transmitted by RED 221 (FIG. 2). The reflected energy from the device node and/or associated assets is received by the RED providing information regarding the device node. Information regarding the device node may also be received from the device node itself and may include the power capacity of the on-board energy supply (e.g., battery) of the device node.

At operation 304, one of a plurality of roles or functions of the device node is determine based upon the information determined at operation 302. The external computing system evaluates information about the device nodes. The information includes which roles the device node is capable of performing. The system uses this information to determine what roles should be assigned (e.g., how many of each role and to which device node).

As discussed above each of the device nodes may be capable of performing several roles or functions when enabled and instructed to do so. The device node role management system may use information regarding the device node to determine a role to be performed by the device node. For example, the system may determine that there is wireless communication interference between device nodes. For example, the interference may be caused by pallets placed too close together. To address the interference, the system may instruct some of the device nodes to cease communication. The system may determine that one or more device nodes should perform a monitoring role to determine when the interference has subsided.

The system is aware of the roles each device node is capable of performing, and a device node will not be selected to perform a role unless the device node is capable of performing the role. For example, the system may not select nodes with limited communication capabilities as routing nodes and may not select nodes with limited computing capabilities as routing or analysis nodes. Additionally, some device may be more suitable to perform a role than other device nodes and such device may be selected to perform the role. For example, some device nodes may include a machine learning (ML) accelerator or ML block, and such device nodes may be selected as analysis nodes rather than those device nodes that don't include an ML block.

Power capacity of the device node also affects whether a device node will be selected to perform a role. For example, a device node with low battery will not be selected as a routing node. Likewise, the system may change which device nodes are routing nodes based on the power level of a device node currently performing routing functions and/or other device nodes (e.g., nearby device nodes).

At operation 306 a power level state of the device node associated with the role to be performed is enabled. Each of the several roles that a device node is capable of performing has an associated power level state.

If the system determines that a device node should perform a role, the system communicates with the device node to enable the power level state associated with that role. For example, the system may determine that a device node should perform a monitoring role to monitor wireless communication interference. The system then communicates with the device node to enable the device mode to enter the power level state associated with the monitoring role. The system may subsequently determine that the interference has subsided and communicate with the device node to enter a different power level state.

In this way the power level state of the devices nodes is controlled externally by the device node role management system to use device node power more efficiently. For example, routing device nodes may not need to power up blocks used for analysis, and analysis device nodes may not need perform all the communication operations of a routing device. Or, for example, a device node may have the ability to perform a power transfer role with a dual antenna to efficiently aim the beam. When the device node is communicating only one antenna may be activated and a second antenna may be activated when the device node performs the power transfer role.

At operation 308 the device node is instructed to actuate the determined role or function. When the role or function has been performed the system communicates with the device node to return the lowest power state that the device node was instructed to go to. Examples of the disclosure may use beam steered signals to enable power level states associated with the role to be performed by the device node. For such examples, when energy from the REDs is no longer directed to the device node, the device node will return to its lowest allowed power level state.

In this manner, examples of the present disclosure can dynamically manage device node roles and the associated power level states such that device nodes remain in a lower power level state that consumes little or no energy until a higher power level state is needed to perform a role.

A visibility management system employing a device node role management system depends upon reliable communication between the device nodes and other elements of the system where communication between some nodes and elements may not be continually maintained.

FIG. 4 illustrates an example mesh topology 400 of the visibility management system 100 of FIG. 1.

In FIG. 4, mesh topology 400 includes gateway 118 and cloud 116 that are communicatively coupled via a backbone 417. Gateway 118 and anchor nodes 128, 102, 112 and 126 are also communicatively connected via a link 402. Thus, gateway 118 can communicate instructions to anchor nodes 128, 102, 112 and 126 to change the power level states of relevant device nodes to effect device node role management.

The anchor nodes may also communicate with aggregated node groups within their zone or zones of operation. Thus, anchor nodes 128, 102, 112 and 126 may communicate with each other via link 409 or via gateway 118. Anchor node 128 may then communicate with aggregated node group 124 (e.g., device node 124A via link 414) and may further communicate with another aggregated node group 106 (e.g., device node 106N via link 420). This mesh network topology 400 allows communication between device nodes of an aggregated node group. For example, in aggregated node group 124, device node 124A and device node 124C can communicate via link 442. Device node 124A can also communicate with device node 124B via link 440.

Device node 124B may communicate with device node 124N via any one of several multi-path links. This same inter-node connectivity is shared by device nodes in other aggregated node groups 106, 110 as shown in FIG. 4. In one example, communication between the device nodes is via Bluetooth LE and communication between device nodes and anchor nodes is also via Bluetooth LE.

Mesh network topology 400 thus provides inter-device communication to establish improved message routing. Each communication is spatially and temporarily synchronized to avoid channel collision. Each communication is also securely transmitted via authorization via images/streams of images vs edge libraries. This implementation is particularly beneficial where large numbers of nodes are physically aggregated as in the present example. In one example, about 5,000 device nodes and their associated assets are aggregated onto a pallet. The multi-path connections between the nodes also provides redundancy.

As previously noted, each device node has multiple power level states associated with various roles that a device node may be enabled to perform. When the device node role management system determines a role to be performed by a device node, gateway 118 may direct anchor node 128 to send an instruction signal to the device node to enable the device node to enter a power level state associated with the role to be performed by the device node. For some examples the device nodes have a multiple antenna design to allow adjustment of phase and shape (transmission direction and lobes) of the energy and signals that the device node relays.

In the example of FIG. 4, the instruction signals may be received by one or more device nodes and communicated with spatial and temporal synchronization to appropriate device nodes within the network.

Mesh network topology 400 may use RSSI as a measure of inter-node proximity, or may use other techniques including AoA, AoD, ToF, and painted direct mapping techniques.

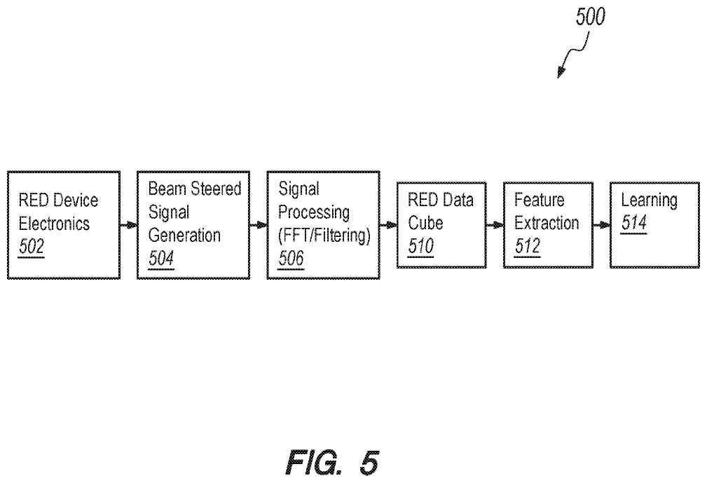

FIG. 5 illustrates an example block diagram for determining information regarding device nodes according to the present disclosure. FIG. 5 shows how information regarding device nodes is obtained and processed to determine a role or function to be performed by a device node.

Device node information acquisition and processing system 500, shown in FIG. 5, includes RED electronics 502. As discussed above, the RED may be implemented as an optical camera, an optical phased array (OPA) with standard camera, a heterodyne OPA, an ultrasonic phased array, or a radio phased array. For one example, multiple RED types are used in combination. The energy beams from different RED types will have different penetration depths, reflectivity, power levels, bandwidth, and data rates. As discussed above, the system employs a broad spectrum of energy emitters to scan the device node and the associated assets, actuate roles and functions of the device node, and map the three-dimensional aggregate node group

The REDs have array designs allowing for phase adjustment as do the other nodes (routing nodes, endpoint nodes) in the environment, to provide time and spatial resolution separation and control within the system.

Beam steered signal generation 504 is used to obtain spatial information regarding the device nodes to locate and identify individual device nodes in the three-dimensional aggregated group. The signal generator steers a beam from one or more REDs to a point in space to target one or more device nodes.

Signal Processing functionality 506 is used to address aspects of the image streams from the REDs, for example wavelength of the reflected energy and image distortion/background noise. The image streams are processed through the signal processing filters.

The RED data cube is the aggregated data from the several sources. The information obtained from the REDs and the signal processing functionality constitute a data feed that creates the RED data cube 510. The aggregation, or fusion, of the data sets allows the system to accurately determine the location of the device node and authenticate the device node. With this information the system can make intelligent decisions regarding aspects of visibility management including assignment of device node roles.

The authentication may occur as follows. In one example, for a static device node, a block-chained library file is sent through the wireless system network for the device node in question to the relevant RED. If the referenced recorded device node matches an existing device node in the system and a corresponding library file, a pattern match process is executed on the image(s) stream sent back to the RED. If the match substantially similar to the previous recorded image stream that was done during registration of the box on the assembly line, the device node is authenticated. Combining in with this data, the object contents, box patterns, etc. that are classified and given a reliability for authenticity. All data may be block-chained. Each tag's unique printed features can make the reflected stream a unique stream for that tag only.

In another example, for a dynamic node for higher security, quantum level needs, the RED system may send through the wireless network, different modulation codes that induce physical movement in the tag based on a known calibration that was done during registration, given the type of tag technology that was made. As in the static node case, the tag sends information on itself through the wireless network. But here, the stream that is reflected back is not a fixed stream, but may be a programmable RED block of changes for that node and image, frame by frame for the stream based on the variation of library files codes sent to the RED tag on the product. Each tag's unique layer, by layer, multi modally sensitivity designed for different RED emitters, creating a multi factorial matrix of possible dynamic image streams unique to the tag, the multilayers modulation, and the code that were sent and verified. Making this multi factorial method quantum level resistantly and very unique. All data may be block chained. A node that cannot be verified may not join the network.

Feature extraction 512 extracts pertinent information from the RED data cube. Such information may include whether or not a device node was activated; this information allows the system to take action to activate the device node. The information may include motion in the space near the device node (which may indicate a person moving near the pallet). The information may also include vibrations of device node which may be important information if the associated asset of the device node is sensitive to vibrations.

The process employs machine learning 514. Feedback from device node performing analysis roles allows the system to build inference and learning models for the use of triggered actions within the network. From the learning process the system obtains outputs to optimize workflow management.

With this information and the machine learning process it is possible for the device node management system to make intelligent decisions about many aspects of visibility management. For example, the device node data acquisition process allows the device node role management system to obtain and evaluate information regarding device nodes as well as learn how to effectively apply that information to determine roles for the device nodes.

As discussed above, there are many possible roles for device nodes in aggregated systems (e.g., inference and local learning mode). For some examples subsets of device nodes have the capability of performing subsets of the roles. The roles can define many different types of functions to address many different concerns of the aggregated node system implementation. For some examples, the roles may be determined as follows. For a routing node, the goal might be a particular latency or bandwidth while minimizing power usage. For an analysis node, the goal might be a time or latency for a problem or amount of work to be done while minimizing power usage. The system can determine how many nodes to assign to each role based on the tradeoffs/goals and/or locations and determine which nodes to assign based on the locations and/or the determination of how many.

In another example, for choosing a routing node assignment, the system may select latency (buffering impact), or bandwidth (channel loads and design) to minimize power usage. A node on the outer skin of a pallet may be assigned a routing node because such a node has a stable backhaul connection to the outside infrastructure and gateway as the primary goal and secondarily on the outside of the pallet all other RED functions can be occur, such functions including recharging, painting, and collection of multiple data sets for real time data fusion, providing the largest and most populated cube set for quick convergence and classification purposes. Given that such outer nodes are the last and most stressed nodes prior to reaching the gateway, power is minimized for such nodes for high reliability and quick convergence. Maintaining the outer skin nodes avoids an unstable interface between the pallets and the infrastructure network that can slow down processing.

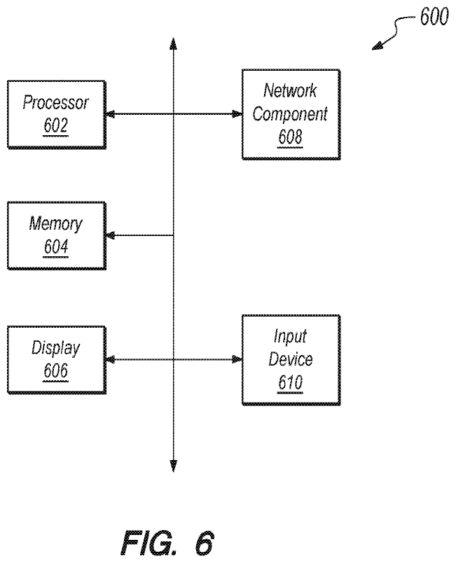

For the internal pallet routing node cases, for some examples, 2 hops (3 routing nodes) may be used. In other examples, 4 hops (3 routing nodes) may be employed. For other examples, no routing may be employed but for the surface nodes of the pallets and for role changing the layer below this layer from the surface. Internal node functionality may depend upon the tradeoffs/goals discussed above. Given standard buffering and memory limitations to a fixed bandwidth of a certain path/node, alternates or parallel paths may be chosen to create a healthy and more stable network, improve load, power look ahead and increase reliability of the network. FIG. 6 illustrates a computer system architecture suitable for implementing examples of components to manage device node roles in an aggregated node system in accordance with the present disclosure. System 600 may facilitate the determination of information regarding a device node and the determination of a role to be performed by the device based upon the information. System 600 may implement a gateway or an anchor node that enables a power level state of the device nodes associated with the role.

System 600 may execute, under control of processor 602, machine executable software instructions stored in memory 604 to perform operations to effect device node role management as described above in reference to FIG. 3. For example, the processor 602 may receive information regarding a device node and determine a role to be performed by the device node based upon the information.

Here, memory 604 may include various memory types, data storage, or non-transitory computer-readable storage media. A user may utilize input device 610 to execute a browser or other machine executable software instructions to facilitate device node role management according to examples of the present disclosure.

An anchor node may be communicatively coupled to a gateway via network component 608. Display 606 which may be, for example, a touch screen interface may visually display information regarding a device node and a role to be performed by a device node.

Examples of the present disclosure have been described as including various operations. Many of the processes or methods are described in their most basic form, but operations can be added to or deleted from any of the processes or methods without departing from the scope of the invention.

While the above is a complete description of specific examples of the disclosure, additional examples are also possible. Thus, the above description should not be taken as limiting the scope of the disclosure, which is defined by the appended claims along with their full scope of equivalents.

1. A method comprising:
determining information regarding a device node of an aggregated node group, each device node of the aggregated node group having multiple power level states;
determining one of a plurality of roles of the device node based upon the information, each role having an associated power level state;
enabling the power level state associated with the role of the device node; and
instructing the device node to actuate the determined role.

2. The method of claim 1 wherein the information regarding the device node is determined by a reflected energy device.

3. The method of claim 1 wherein enabling the power level state associated with the role or function of the device includes transmitting an energy beam from a reflected energy device to the device node.

4. The method of claim 1 wherein the information regarding the device node includes the location of the device node within aggregated node group.

5. The method of claim 1 wherein the information regarding the device node includes a set of roles that the device node is capable of performing.

6. The method of claim 1 wherein the device node enters a lower power level state after the role is performed.

7. The method of claim 1 wherein the device node receives power to perform the role from another device node of the aggregated node group performing a power relay role.

8. A system for managing roles of device nodes in an aggregated node group comprising:
a reflected energy device to communicate energy to a device node of a plurality of device nodes, wherein each device node is to perform multiple roles, each of the multiple roles associated with a corresponding power level state of the device node, wherein a reflected energy from the device node used is to determine information regarding the device node;
a processor to determine, a role to be performed by the device node based upon the information regarding the device node; and
a communication device to transmit a signal to the device node to enable the power level state associated with the role and instruct the device node to perform the role.

9. The system of claim 8 wherein the aggregated node group is implemented as a mesh network.

10. The system of claim 8 wherein the communication device is the reflected energy device or an anchor node.

11. The system of claim 8 wherein the information regarding the device node is determined through a machine learning process.

12. The system of claim 8 wherein the reflected energy device is implemented as one or more of an optical camera, an optical phased array, an ultrasonic phased array, and a radio phased array.

13. The system of claim 8 wherein the information regarding the device node includes a capability of the device node to communicate with other device nodes of the aggregated node group.

14. The system of claim 8 wherein the information regarding the device node includes a power capacity of an on-board battery of the device node.

15. The system of claim 8 wherein a set of roles that the device node is capable of performing is determined by a location of the device node within the aggregated node group.
